(19) United States
(12) Patent Application Publication
(10) Pub. No.: US 2025/0192368 A1
(43) Pub. Date: Jun. 12, 2025

(54) XYLEM FOR USE IN BATTERY APPLICATIONS AND PROCESSING METHOD FOR THE SAME

(71) Applicant: Xylia, Inc., Stanford, CA (US)

(72) Inventor: Stefán Ás Ingvarsson, Stanford, CA (US)

(73) Assignee: Xylia, Inc., Stanford, CA (US)

(21) Appl. No.: 18/966,495

(22) Filed: Dec. 3, 2024

Related U.S. Application Data
(60) Provisional application No. 63/607,877, filed on Dec. 8, 2023.

(51) Int. Cl. H01M 50/457; H01M 4/02; H01M 4/38; H01M 4/485; H01M 4/58; H01M 4/583; H01M 50/403; H01M 50/429

(52) U.S. Cl. CPC H01M 50/457; H01M 4/38; H01M 4/485; H01M 4/5815; H01M 4/583; H01M 50/403; H01M 50/4295; H01M 2004/027; H01M 2004/028

(57) ABSTRACT

The present disclosure describes a battery which may include an anode including an alkali metal, an alkaline earth metal, or a combination thereof; a cathode including a carbon allotrope; a porous separator including xylem coated with a coating material, and an electrolyte. Coated xylem compositions and methods for preparing the same are also disclosed.

### CROSS-REFERENCE TO RELATED APPLICATIONS

This application claims priority to U.S. Provisional Patent Application No. 63/607,877, filed on Dec. 8, 2023, which is hereby incorporated by reference in its entirety.

### FIELD

The present disclosure relates generally to coated xylem compositions and methods of making the same. More specifically, the present disclosure relates to coated xylem which may be used in battery applications.

### BACKGROUND

Lithium-ion batteries have long been studied as effective energy storage devices. However, lithium-ion batteries have several drawbacks, including a limited supply of raw materials, increasing cost, and environmental concerns. There is a pressing need to develop affordable and sustainable battery technologies without sacrificing performance.

Calcium-ion batteries are a promising alternative to lithium-ion batteries, as calcium is widely available with the potential for higher specific capacity than lithium. Despite this theoretical promise, previous examples of calcium-ion batteries suffer from poor cycling stability and reversibility during battery operation. In addition, the identification of suitable electrodes and electrolytes that are compatible with calcium remains a challenge. Battery architecture requires transport pathways that permit the transport of calcium ions, as their larger size and higher charge density relative to lithium present an obstacle towards the realization of efficient and high-performing calcium-ion batteries. There remains a need for materials that permit the efficient transport of calcium ions and allow for calcium-ion batteries with high cycling stability and performance.

### SUMMARY

In some aspects, the techniques described herein relate to a battery, including: an anode including an alkali metal, an alkaline earth metal, or a combination thereof; a cathode including a carbon allotrope; a porous separator including xylem coated with a coating material; and an electrolyte.

In some aspects, the techniques described herein relate to a battery, wherein the anode includes lithium, calcium, potassium, sodium, beryllium, magnesium, zinc, aluminum, or combinations thereof.

In some aspects, the techniques described herein relate to a battery according to any of the above aspects, wherein the cathode includes a carbon allotrope intercalated with CaV₂O₅, CaTiS₂, CaC₆, or combinations thereof.

In some aspects, the techniques described herein relate to a battery according to any of the above aspects, wherein the carbon allotrope includes graphite, graphene, or a combination thereof.

In some aspects, the techniques described herein relate to a battery according to any of the above aspects, wherein the xylem is obtained from a plant of the Crassula, Cycas, Takhtajania, Tasmannia, Drimys, Pseudowintera, Zygogynum, or Tetracentron genera.

In some aspects, the techniques described herein relate to a battery according to any of the above aspects, wherein the xylem is obtained from Crassula ovata, Crassula alata, Crassula capitella, Crassula lactea, Crassula nealeana, Crassula perforata, Cycas revoluta, Cycas tropophylla, Cycas circinalis, Cycas media, Cycas orixensis, Cycas platyphylla, Cycas pectinate, Tetracentron sinense, Drimys andina, Drimys angustifolia, Drimys brasiliensis, Drimys confertifolia, Drimys granadensis, Drimys roraimensis, Drimys winteri, or combinations thereof.

In some aspects, the techniques described herein relate to a battery according to any of the above aspects, wherein the xylem is secondary xylem.

In some aspects, the techniques described herein relate to a battery according to any of the above aspects, wherein the coating material includes polyvinylidene fluoride, polytetrafluoroethylene, polyvinyl chloride, polystyrene, polypropylene, polyethylene, polycarbonate, polyethylene oxide, polymethyl methacrylate, polyacrylonitrile, tetrahydrofuran, ethylene carbonate, propylene carbonate, or combinations thereof.

In some aspects, the techniques described herein relate to a battery according to any of the above aspects, wherein the xylem is further coated with carbon nanotubes.

In some aspects, the techniques described herein relate to a battery according to any of the above aspects, wherein electrolyte includes calcium tetrafluoroborate, sodium hexafluorophosphate, ethylene carbonate, diethyl carbonate, dimethyl carbonate, ethyl methyl carbonate, tetrahydrofuran, or combinations thereof.

In some aspects, the techniques described herein relate to a method of preparing coated xylem, including: applying a coating solution including a coating material to xylem using a coating method to form coated xylem, and drying the coated xylem.

In some aspects, the techniques described herein relate to a method, further including isolating the xylem from Crassula ovata, Crassula alata, Crassula capitella, Crassula lactea, Crassula nealeana, Crassula perforata, Cycas revoluta, Cycas tropophylla, Cycas circinalis, Cycas media, Cycas orixensis, Cycas platyphylla, Cycas pectinate, Tetracentron sinense, Drimys andina, Drimys angustifolia, Drimys brasiliensis, Drimys confertifolia, Drimys granadensis, Drimys roraimensis, Drimys winteri, or combinations thereof.

In some aspects, the techniques described herein relate to a method according to any of the above aspects, further including preparing the coating solution, wherein preparing the coating solution includes dissolving the coating material in a solvent including N-methyl-2-pyrrolidone, dichloromethane, dimethyl carbonate, ethyl methyl carbonate, or combinations thereof.

In some aspects, the techniques described herein relate to a method according to any of the above aspects, wherein the coating material includes polyvinylidene fluoride, polytetrafluoroethylene, polyvinyl chloride, polystyrene, polypropylene, polyethylene, polycarbonate, polyethylene oxide, polymethyl methacrylate, polyacrylonitrile, tetrahydrofuran, or combinations thereof.

In some aspects, the techniques described herein relate to a method according to any of the above aspects, wherein the coating material includes a binder including ethylene carbonate, propylene carbonate, or a combination thereof.

In some aspects, the techniques described herein relate to a method according to any of the above aspects, wherein the coating method includes spin coating, doctor blading, slot-die coating, dip coating, bar coating, or combinations thereof.

In some aspects, the techniques described herein relate to a method according to any of the above aspects, further including applying carbon nanotubes to the xylem.

In some aspects, the techniques described herein relate to a method according to any of the above aspects, wherein drying the coated xylem includes vacuum drying at a temperature of about 25° C. to about 75° C.

In some aspects, the techniques described herein relate to a method according to any of the above aspects, further including annealing the coated xylem.

In some aspects, the techniques described herein relate to a method according to any of the above aspects, further including densifying the xylem.

In some aspects, the techniques described herein relate to a composition, including: xylem isolated from a plant of the Crassula, Cycas, Takhtajania, Tasmannia, Drimys, Pseudowintera, Zygogynum, or Tetracentron genera coated with a coating material.

In some aspects, the techniques described herein relate to a composition, wherein the coating material includes polyvinylidene fluoride, polytetrafluoroethylene, polyvinyl chloride, polystyrene, polypropylene, polyethylene, polycarbonate, polyethylene oxide, polymethyl methacrylate, polyacrylonitrile, tetrahydrofuran, or combinations thereof.

In some aspects, the techniques described herein relate to a composition according to any of the above aspects, wherein the coating material includes a binder including ethylene carbonate, propylene carbonate, or a combination thereof.

In some aspects, the techniques described herein relate to a composition according to any of the above aspects, wherein the coating material includes carbon nanotubes.

In some aspects, the techniques described herein relate to a composition according to any of the above aspects, wherein the xylem is secondary xylem.

In some aspects, the techniques described herein relate to a composition according to any of the above aspects, wherein the plant is Crassula ovata, Crassula alata, Crassula capitella, Crassula lactea, Crassula nealeana, Crassula perforata, Cycas revoluta, Cycas tropophylla, Cycas circinalis, Cycas media, Cycas orixensis, Cycas platyphylla, Cycas pectinate, Tetracentron sinense, Drimys andina, Drimys angustifolia, Drimys brasiliensis, Drimys confertifolia, Drimys granadensis, Drimys roraimensis, Drimys winteri, or combinations thereof.

### DRAWINGS

Aspects, features, benefits, and advantages of the embodiments described herein will be apparent with regard to the following description, appended claims, and accompanying drawings where:

FIG. 1A is an image depicting wood-based xylem. FIG. 1B is an image depicting xylem from a flowering plant, according to an embodiment of the present disclosure. FIG. 1C is a close-up image of xylem from a flowering plant, according to an embodiment of the present disclosure. FIG. 1D is an image of the transport network of xylem, according to an embodiment of the present disclosure.

FIG. 2A is an SEM image of xylem with acetonitrile, and FIG. 2B and FIG. 2C are SEM images of xylem coated with PVDF, according to embodiments of the present disclosure.

FIG. 3 is an image of xylem coated with PVDF and doped with gold, according to an embodiment of the present disclosure.

FIG. 4 is a flow chart of a method of preparing coated xylem, according to an embodiment of the present disclosure.

FIG. 5 is an illustrative diagram of a battery, according to an embodiment of the present disclosure.

FIG. 6A is a graph showing the relationship of xylem thickness to conductivity in a calcium chloride electrolyte solution, according to an embodiment of the present disclosure. FIG. 6B is a graph showing the relationship of xylem thickness to conductivity in a calcium triflate electrolyte solution, according to an embodiment of the present disclosure.

FIG. 7A is a graph of electrochemical impedance spectroscopy (EIS) of calcium chloride compared to calcium chloride with the coated xylem of the present disclosure. FIG. 7B is a graph of electrochemical impedance spectroscopy (EIS) of calcium triflate compared to the coated xylem of the present disclosure having a thickness of 250 μm, 400 μm, and 140 μm.

### DETAILED DESCRIPTION

According to embodiments of the present disclosure, there is provided a coated xylem which may be used in battery applications. Methods of coating the xylem and a battery containing the same are also described herein.

Before describing the embodiments in detail, the following definitions are used throughout the present disclosure.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

As used herein, the term “about” means plus or minus 10% of the numerical value of the number with which it is being used. For example, “about 50%” means in the range of 45-55% and also includes exactly 50%. Stated differently, where any value is described herein as modified by the term “about”, the exact value is also disclosed.

In embodiments, there is provided a composition which includes xylem isolated from a plant of the Crassula genus, a plant of the Cycas genus, or other vesselless angiosperm coated with a coating material. The coating material may include, for example, polymers, metals, binders, the like, and combinations thereof. For example, the coating material may include a thermoplastic polymer and a binder. In embodiments, the xylem can be secondary xylem. It is contemplated that xylem, particularly xylem isolated from plants of the Crassula or Cycas genera, possesses a nanopore structure with a pore size that allows the xylem to act as an efficient ion transport material. Xylem from other vesselless angiosperm plants is contemplated to possess similar characteristics and may be incorporated into the methods and compositions of the present disclosure. For example, xylem from plants of the Crassula genus, including but not limited to Crassula ovata, Crassula alata, Crassula capitella, Crassula lactea, Crassula nealeana, Crassula perforata, the like, and other plants from the Crassula genus may also be utilized as disclosed herein. Xylem from plants of the Cycas genus is also contemplated, including but not limited to Cycas revoluta, Cycas tropophylla, Cycas circinalis, Cycas media, Cycas orixensis, Cycas platyphylla, Cycas pectinata, the like, and other plants from the Cycas genus may be used as described herein. Xylem from other vesselless angiosperms, including but not limited to plants of the Winteraceae family (including the Takhtajania, Tasmannia, Drimys, Pseudowintera, and Zygogynum genera), and the Tetracentron genus, is also contemplated. Species of plants from which xylem may be obtained include, but are not limited to, Tetracentron sinense, Tetracentron atlanticum, Drimys andina, Drimys angustifolia, Drimys brasiliensis, Drimys confertifolia, Drimys granadensis, Drimys roraimensis, Drimys winteri, and the like. Combinations of xylem from multiple species are also contemplated and may be used as described herein.

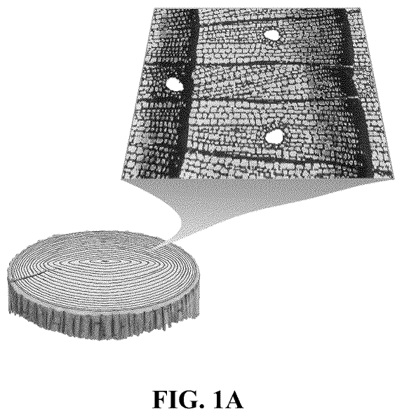

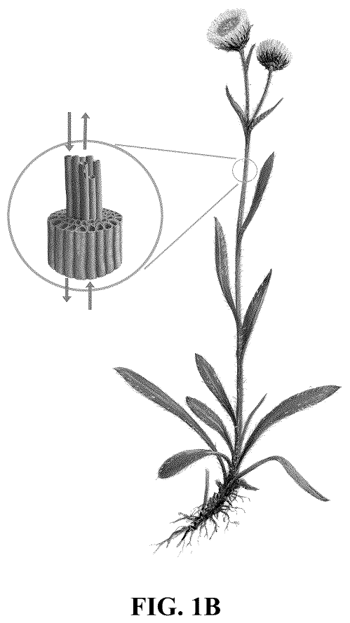

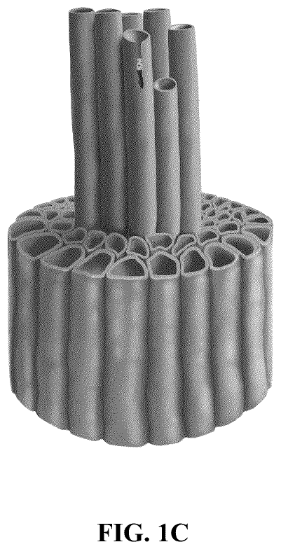

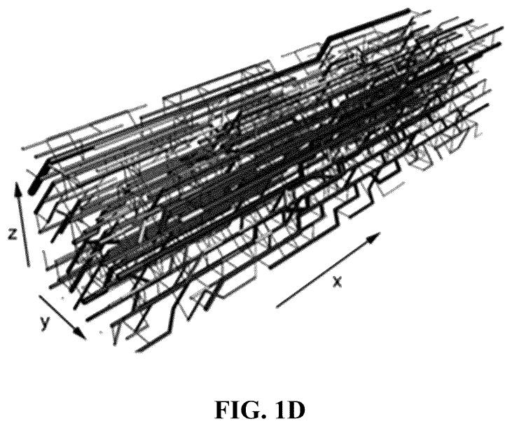

Coating the xylem with the coating material, such as a thermoplastic polymer, is contemplated to add additional structural support and integrity of the xylem, and further provide enhancement of ion transport capability and energy density and capacity to the xylem, relative to uncoated xylem. The present disclosure contemplates coatings which achieve the aforementioned properties without changing the native pore structure of the xylem. FIG. 1A is an image depicting wood-based xylem. Without wishing to be bound by theory, it is contemplated that wood-based xylem may contain a pore structure that is too large for the ion transport applications disclosed herein. Xylem from other sources, such as flowering plants, succulents, and the like, may possess the desired pore structure. FIG. 1B is an image depicting xylem from a flowering plant, according to an embodiment of the present disclosure. FIG. 1C is a close-up image of xylem from a flowering plant, according to an embodiment of the present disclosure.

In embodiments, the coating material can include a polymer. In embodiments, the polymer can include polyvinylidene fluoride, polytetrafluoroethylene, polyvinyl chloride, polystyrene, polypropylene, polyethylene, polycarbonate, polyethylene oxide, polymethyl methacrylate, polyacrylonitrile, or combinations thereof. Non-polymer coating materials including boron, sodium, tetrahydrofuran, carboxymethyl cellulose, metals, and combinations thereof are also contemplated, and may be used alone or in combination with polymer coating materials. In embodiments, the coating material can include a binder, alone or in combination with other coating materials disclosed herein. The binder can include ethylene carbonate, propylene carbonate, or a combination thereof. Any combination of coating materials disclosed herein is within the scope of the present disclosure. In embodiments, the inclusion of the binder may improve adhesion of the coating to the xylem and improve the flexibility of the resulting coated xylem, without wishing to be bound by theory.

The coated xylem of the present disclosure may, in embodiments, have a nanoporous structure which may allow the transport of ions, without wishing to be bound by theory. FIG. 1D is an image of the transport network of xylem, according to an embodiment of the present disclosure.

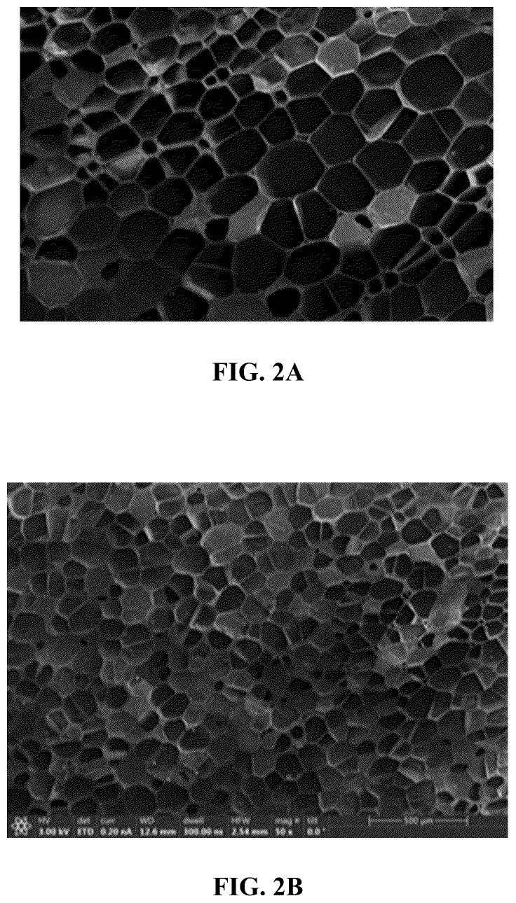

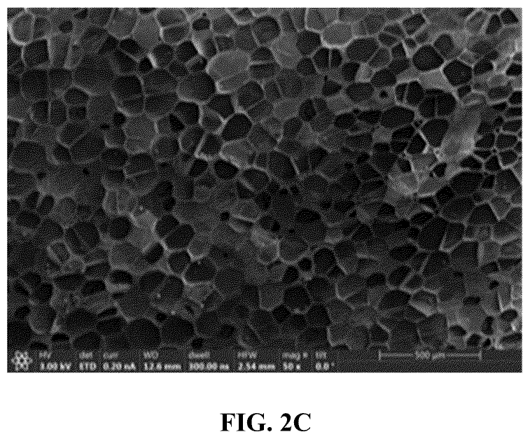

It is contemplated that secondary xylem isolated from Crassula ovata and other plants disclosed herein exhibits sufficient rigidity and appropriate pore structure to serve as an ion transport material. The coated xylem of the present disclosure maintains the pore structure of the original, uncoated xylem after coating as described herein. FIG. 2A is an SEM image of xylem with acetonitrile, and FIG. 2B and FIG. 2C are SEM images of xylem coated with PVDF, according to embodiments of the present disclosure. As shown, the pore structure of the uncoated xylem in FIG. 2A is maintained in the coated xylem of FIG. 2B and FIG. 2C, which supports the ability of the presently disclosed coatings to enhance the structural support of the xylem without sacrificing the pore structure.

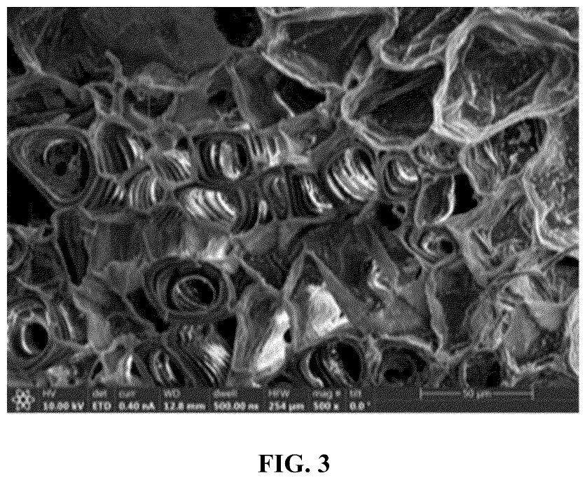

In embodiments, the coated xylem may be further doped or coated with additional additives, such as metals, other polymers, non-polymer coatings, or combinations thereof. In embodiments, the coated xylem may be doped with metals such as gold, manganese, iron, cobalt, nickel, zinc, silver, cadmium, palladium, carbon nanotubes, or combination thereof. Other transition metals or materials that may facilitate the transport of calcium ions may also be utilized, without wishing to be bound by theory. FIG. 3 is an image of xylem coated with PVDF and doped with gold, according to an embodiment of the present disclosure.

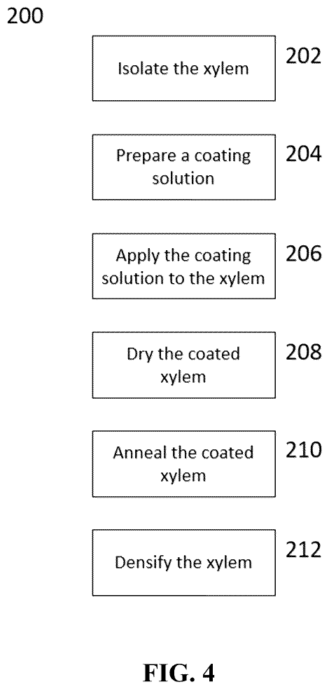

In embodiments, there is provided a method of preparing coated xylem. FIG. 4 is a flow chart of a method of preparing coated xylem, according to an embodiment of the present disclosure. The method 200 may include a step of 202 isolating the xylem, a step 204 of preparing a coating solution, a step 206 of applying the coating solution to the xylem to form coated xylem, a step 208 of drying the coated xylem, and a step 210 of annealing the coated xylem.

In embodiments, the method 200 may include a step of 202 isolating the xylem from a suitable plant, such as Crassula ovata, Crassula alata, Crassula capitella, Crassula lactea, Crassula nealeana, Crassula perforate, Cycas revoluta, Cycas tropophylla, Cycas circinalis, Cycas media, Cycas orixensis, Cycas platyphylla, Cycas pectinate, Tetracentron sinense, Drimys andina, Drimys angustifolia, Drimys brasiliensis, Drimys confertifolia, Drimys granadensis, Drimys roraimensis, Drimys winteri, the like, or combinations thereof. The method of isolating the xylem is not particularly limited and may be performed according to standard procedures known to those skilled in the art. In embodiments, the xylem may be secondary xylem. In embodiments, the step 202 is not required, and pre-isolated xylem may be utilized.

In embodiments, the method can include a step 204 preparing a coating solution including the coating material, wherein preparing the coating solution includes dissolving the coating material in a solvent which includes N-methyl-2-pyrrolidone, dichloromethane, dimethyl carbonate, ethyl methyl carbonate, ethylene carbonate, propylene carbonate, or combinations thereof. The solvent and concentration of the coating solution depends on the specific components of the coating material and may be adjusted as needed by one of ordinary skill in the art to provide a coating solution with an appropriate viscosity for coating the xylem. The coating solution may be heated to dissolve the thermoplastic polymer and the binder, if needed. The temperature of heating is not particularly limited and may be adjusted depending on the coating materials used and the solubility of the coating materials in the chosen solvent. Other dissolution aids such as stirring, sonication, or combinations thereof may also be utilized. In embodiments, the step 204 is not required, and a pre-made solution may be used.

In some embodiments, the viscosity of the coating solution can be able 1 centipoise (cP) to about 6000 cP, such as about 1 cP, about 10 cP, about 50 cP, about 100 cP, about 500 cP, about 1000 cP, about 1500 cP, about 2000 cP, about 2500 cP, about 3000 cP, about 3500 cP, about 4000 cP, about 4500 cP, about 5000 cP, about 5500 cP, about 6000 cP, or any value contained within a range formed by any two of the preceding values.

In embodiments, the coating material includes a thermoplastic polymer and a binder. In such embodiments, the thermoplastic polymer and the binder may be combined in a molar ratio of about 5:1, about 4:1, about 3:1, about 2:1, about 1:1, about 1:2, about 1:3, about 1:4, about 1:5, or any value contained within a range formed by any two of the preceding values.

In embodiments, the thermoplastic polymer can include polyvinylidene fluoride, polytetrafluoroethylene, polyvinyl chloride, polystyrene, polypropylene, polyethylene, polycarbonate, polyethylene oxide, polymethyl methacrylate, polyacrylonitrile, or combinations thereof. In embodiments, the binder can include ethylene carbonate, propylene carbonate, or a combination thereof.

In some embodiments, multiple coating solutions are applied to the xylem. For example, a first coating solution including coating material as described herein, such as a thermoplastic polymer and a binder in a solvent, can be applied, and a second coating solution including a coating material as described herein and an additional component can be applied to the xylem.

In embodiments, the step 206 of applying the coating solution to the xylem with the coating method can include spin coating, doctor blading, slot-die coating, dip coating, bar coating, or combinations thereof. Other methods of coating that will be familiar to those skilled in the art may also be acceptable. Any variations or parameters used in the disclosed coating methods are within the scope of the present disclosure. It is contemplated that the coating method may be chosen based on the viscosity of the solution and the specific components used in the solution, according to embodiments of the present disclosure. Those skilled in the art will further recognize that different coating methods may result in different surface characteristics, and may select a coating method based on the desired characteristics for the coated xylem. In embodiments, step 206 of applying the coating solution to the xylem results in uniform deposition of the coating material and structural and porous integrity of the coated xylem.

In some embodiments, the coating method includes slot-die coating, particularly in embodiments wherein the coating material includes carbon nanotubes. Slot-die coating can, in some embodiments, provide a straightforward method to apply multiple coating solutions to the xylem using a single device, which may simplify the overall method. In some embodiments, parameters for slot-die coating such as flow rate, coating speed, viscosity of the coating solution, and the like may be adjusted depending on the size of the xylem to be coated, the specific properties desired, and other factors. Non-limiting examples of these parameters may include a flow rate of about 0.1 mL/min to about 10 mL/min per centimeter of coating width, such as about 0.1 mL/min, about 0.5 mL/min, about 1 mL/min, about 2 mL/min, about 3 mL/min, about 4 mL/min, about 5 mL/min, about 6 mL/min, about 7 mL/min, about 8 mL/min, about 9 mL/min, about 10 mL/min, or any value contained within a range formed by any two of the preceding values. A coating speed of about 0.1 m per minute (m/min) to about 10 m/min may be used, such as about 0.1 m/min, about 0.5 m/min, about 1 m/min, about 2 m/min, about 3 m/min, about 4 m/min, about 5 m/min, about 6 m/min, about 7 m/min, about 8 m/min, about 9 m/min, about 10 m/min, or any value contained within a range formed by any two of the preceding values. In some embodiments, the slot height used for slot-die coating can be about 50 μm to about 5 mm, such as about 50 μm, about 100 μm, about 500 μm, about 1 mm, about 2 mm, about 3 mm, about 4 mm, about 5 mm, or any value contained within a range formed by any two of the preceding values.

In some embodiments, the xylem may be further coated with carbon nanotubes. For example, in some embodiments, carbon nanotubes may be applied to the xylem after the coating solution is applied. The carbon nanotubes may be present in an amount of about 0.01 wt. % to about 5 wt. % relative to the total weight of the coated xylem, such as about 0.01 wt. %, about 0.05 wt. %, about 0.1 wt. %, about 0.5 wt. %, about 1 wt. %, about 1.5 wt. %, about 2 wt. %, about 2.5 wt. %, about 3 wt. %, about 3.5 wt. %, about 4 wt. %, about 4.5 wt. %, about 5 wt. %, or any value contained within a range formed by any two of the preceding values. Carbon nanotubes may function as a conductive additive, in some embodiments, and may increase the conductivity of the resulting coated xylem.

In some embodiments, various methods of applying or growing carbon nanotubes on the xylem surface may be used. Such methods include electrophoretic deposition (EPD), chemical vapor deposition (CVD), electrochemically assisted deposition, wet or dry spin coating, vacuum filtration, or combinations thereof. In some embodiments, such methods of applying carbon nanotubes to the xylem may be used sequentially, such as CVD followed by EPD. Using sequential carbon nanotube deposition methods may, in some embodiments, result in a uniform coverage of the xylem with carbon nanotubes.

In embodiments, the step 208 of drying the coated xylem can include vacuum drying or other drying methods. Drying may be performed at room temperature, or at an elevated temperature. In embodiments, drying the coated xylem may include drying at a temperature of about 25° C. to about 75° C., such as about 25° C., about 30° C., about 35° C., about 40° C., about 45° C., about 50° C., about 55° C., about 60° C., about 65° C., about 70° C., about 75° C., or any value contained within a range formed by any two of the preceding values. The temperature and time of drying may be adjusted as needed depending on the thickness of the coating and the specific coating composition and solvent used. One of skill in the art may adjust the drying parameters as necessary to ensure removal of excess solvent and uniform drying of the coating.

In embodiments, the method may further include a step 210 of annealing the coated xylem. Any method of annealing known to those skilled in the art may be employed in the presently disclosed method. Without wishing to be bound by theory, annealing the coated xylem may induce surface properties that have a beneficial effect on the ionic conductivity and other performance metrics, when the coated xylem is used in battery applications. In particular, annealing the coated xylem may aid in ensuring uniform deposition of the coating material. A uniform coating is desirable for providing a stable and well-formed solid electrolyte interphase (SEI) layer and favorable ionic conductivity within the coated xylem. In embodiments, the method may further include other treatments or processing steps after drying the coated xylem to achieve specific material properties. In embodiments, the method may include treatment steps such as successive ionic layer adsorption and reaction (SILAR), hydrothermal synthesis, or combinations thereof. In embodiments, the step 210 is not required, such that the coated xylem may be used after drying without further treatment.

Coating the xylem as described herein results in a film on the xylem substrate. In some embodiments, the thickness of the film can be about 1 μm to about 500 μm, such as about 1 μm, about 5 μm, about 10 μm, about 50 μm, about 100 μm, about 150 μm, about 200 μm, about 250 μm, about 300 μm, about 350 μm, about 400 μm, about 450 μm, about 500 μm, or any value contained within a range formed by any two of the preceding values.

In some embodiments, the method can further include a step 212 of densifying the xylem. Densifying the xylem can include applying a pressure to the xylem such that the xylem is condensed, thus reducing the size and increasing the density. A pressure of about 1 mPa to about 10 mPa is contemplated, though other pressures may be used as appropriate. For example, a pressure of about 1 mPa, about 2 mPa, about 3 mPa, about 4 mPa, about 5 mPa, about 6 mPa, about 7 mPa, about 8 mPa, about 9 mPa, about 10 mPa, or any value contained within a range formed by any two of the preceding values. The pressure may be applied for any length of time suitable to yield a densified xylem structure; it will be understood that a longer time may be required when a lower pressure is used while a shorter time may be appropriate when a higher pressure is used. In some embodiments, densification as described herein strengthens the xylem and results in improved properties including but not limited to physical durability, conductivity, battery cycle life, the like, and combinations thereof. In some embodiments, step 212 of densifying the xylem can be performed before step 206 of applying the coating solution, after step 206 of applying the coating solution, after step 208 of drying the coated xylem, or after step 210 of annealing the coated xylem; that is, densification may be performed at any point during the presently disclosed method. In some embodiments, densification is not performed, such that the method does not include step 212.

It is contemplated that the method disclosed herein may be modified depending on the coating material used. In embodiments, the method of coating the xylem with a coating material may include one or more of the above-described steps, alone or in combination with other disclosed steps. For example, in embodiments, the coating method may include successive ionic layer adsorption and reaction (SILAR) or hydrothermal synthesis instead of coating methods such as spin coating, doctor blading, slot-die coating, dip coating, bar coating, and the like. The parameters used for such coating methods may be determined by one of ordinary skill in the art.

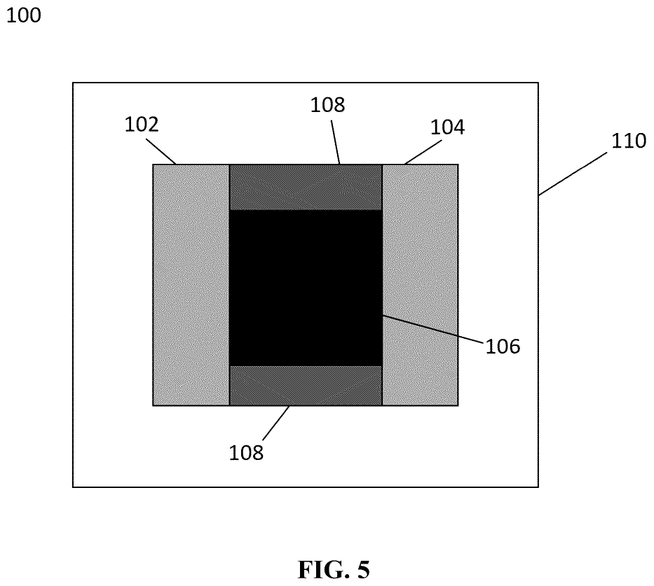

In embodiments, there is provided a battery which includes an anode including an alkali metal, an alkaline earth metal, or a combination thereof; a cathode including a carbon allotrope; a porous separator including xylem coated with a thermoplastic polymer; and an electrolyte. FIG. 5 is an illustrative diagram of a battery, according to an embodiment of the present disclosure. In embodiments, the battery 100 may include an anode 102, a cathode 104, a porous separator 106, an electrolyte 108, and optionally, a housing 110.

In embodiments, the anode 102 may include lithium, calcium, potassium, sodium, beryllium, magnesium, zinc, aluminum, or combinations thereof. In embodiments, the anode 102 may include calcium metal. Other anode materials can include, but are not limited to, graphitic carbon, organic and metal-organic frameworks, calcium-containing alloys (such as calcium alloyed with gallium), and the like.

In embodiments, the cathode 104 includes a carbon allotrope intercalated with CaV₂O₅, CaTiS₂, CaC₆, or combinations thereof. The carbon allotrope may include graphite, graphene, or a combination thereof. Other cathode materials, including but not limited to Prussian blue analogues, layered metal oxides, chalcogenides, fluorides, polyanionic materials, and the like are also contemplated.

In embodiments, the porous separator 106 facilitates the transport of calcium ions. Accordingly, the porous separator 106 may have a structure (including porosity, interconnection, and the like) that permits calcium ions to be transported during battery operation. In embodiments, the porous separator 106 includes xylem isolated from a plant of the Crassula, Cycas, Takhtajania, Tasmannia, Drimys, Pseudowintera, Zygogynum, or Tetracentron genera. In embodiments, the porous separator 106 includes xylem that is obtained from Crassula ovata, Crassula alata, Crassula capitella, Crassula lactea, Crassula nealeana, Crassula perforate, Cycas revoluta, Cycas tropophylla, Cycas circinalis, Cycas media, Cycas orixensis, Cycas platyphylla, Cycas pectinate, Tetracentron sinense, Drimys andina, Drimys angustifolia, Drimys brasiliensis, Drimys confertifolia, Drimys granadensis, Drimys roraimensis, Drimys winteri, the like, or combinations thereof. As described herein, the xylem used in the battery of the present disclosure may be selected according to its pore structure and ion transport capability. In embodiments, the xylem is secondary xylem, and may be coated with a coating material as described herein. In embodiments, the xylem is coated with a coating material which includes a polymer such as polyvinylidene fluoride, polytetrafluoroethylene, polyvinyl chloride, polystyrene, polypropylene, polyethylene, polycarbonate, polyethylene oxide, polymethyl methacrylate, polyacrylonitrile, or combinations thereof. In some embodiments, the xylem is further coated with carbon nanotubes.

In embodiments, the electrolyte 108 can include calcium tetrafluoroborate, sodium hexafluorophosphate, ethylene carbonate, diethyl carbonate, dimethyl carbonate, ethyl methyl carbonate, tetrahydrofuran, Ca(BF₄)₂NaPF₆, or combinations thereof.

In embodiments, the battery 100 is optionally contained within a housing 110. The housing 110 may be formed from any suitable material, such as plastics, metals, the like, or combinations thereof, which do not interfere with the operation of the battery. The material and dimensions of the housing 110 are not particularly limited. In embodiments, the housing 110 is omitted, such that it is not present.

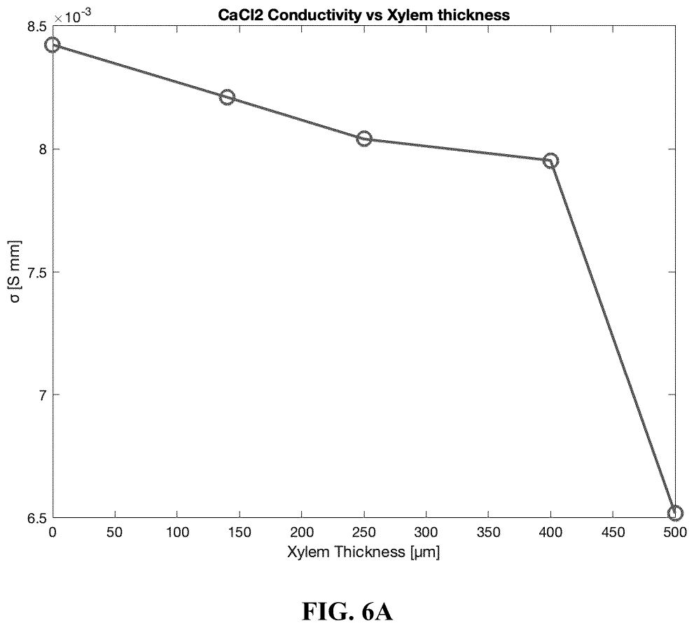

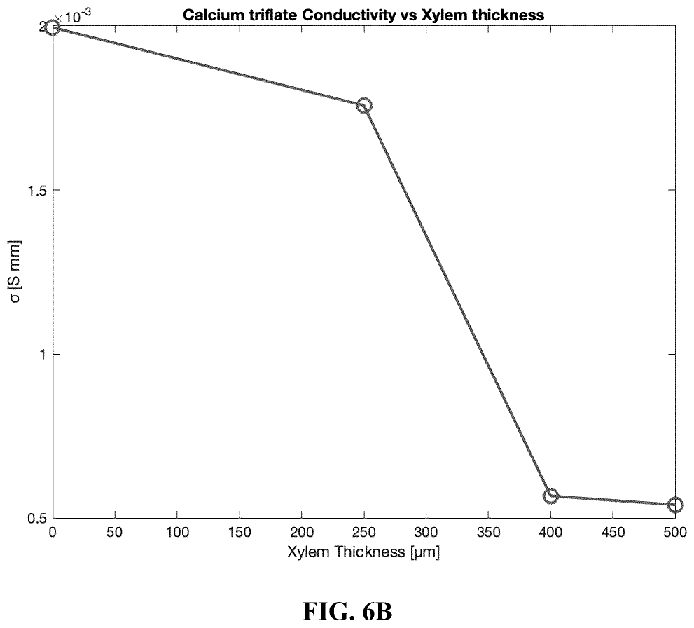

In embodiments, the thickness of the porous separator is related to the conductivity in various electrolyte solutions, summarizing the relationship between the xylem thickness and the ionic conductivity. FIG. 6A is a graph showing the relationship of xylem thickness to conductivity in a calcium chloride electrolyte solution, according to an embodiment of the present disclosure. FIG. 6B is a graph showing the relationship of xylem thickness to conductivity in a calcium triflate electrolyte solution, according to an embodiment of the present disclosure. As shown, conductivity decreases with increasing xylem thickness.

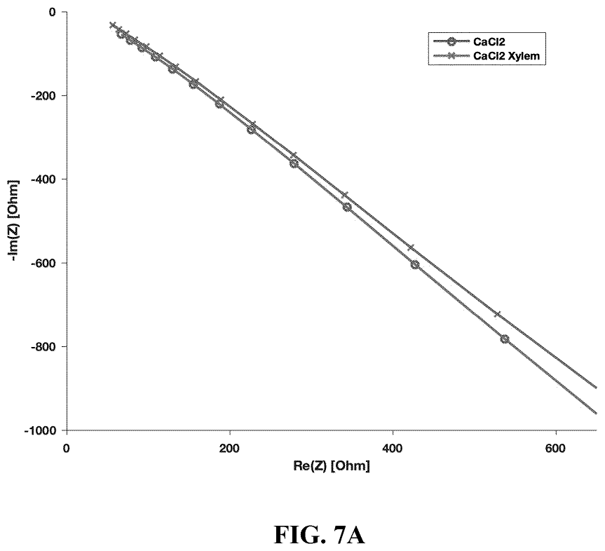

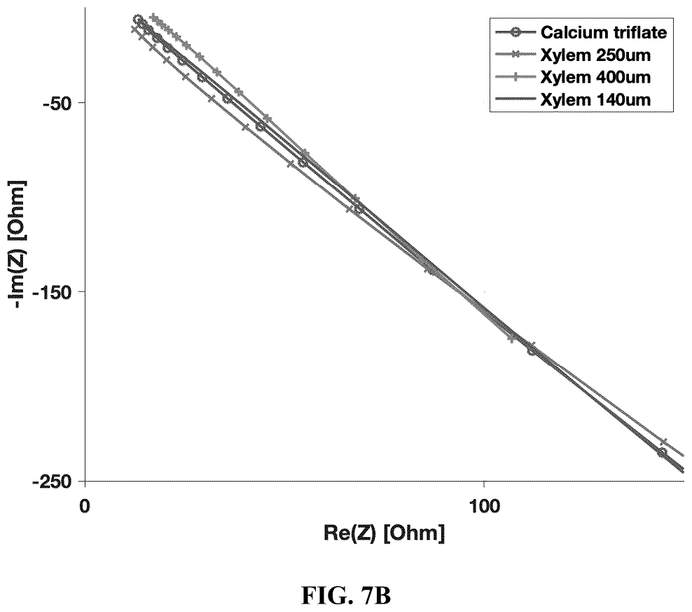

FIG. 7A is a graph of electrochemical impedance spectroscopy (EIS) of calcium chloride compared to calcium chloride with the coated xylem of the present disclosure. FIG. 7B is a graph of electrochemical impedance spectroscopy (EIS) of calcium triflate compared to the coated xylem of the present disclosure having a thickness of 250 μm, 400 μm, and 500 μm. Importantly, the EIS measurements demonstrate the ionic conductivity of the coated xylem when soaked in the chosen calcium electrolytes. The calcium electrolytes utilized in FIGS. 7A and 7B are well-known electrolytes and have established ionic conductivity values, and thus were also used as the control measurements (without the xylem), as shown in the figures. The ionic conductivity values obtained as controls matched well with reported literature values. The results in FIGS. 7A and 7B show that the coated xylem, remarkably, does not inhibit or diminish the ionic conductivity of the calcium electrolytes alone. Without wishing to be bound by theory, the ionic conductivity through the coated xylem is exceptionally competitive against other solid electrolyte structures, as the presently disclosed coating xylem outperforms literature examples of solid electrolyte structures by at least about 10³ S*mm. FIG. 7A and FIG. 7B demonstrate excellent ionic conductivity of the coated xylem of the present disclosure. It is contemplated that the coated xylem of the present disclosure exhibits similarly high performance with other electrolytes, such as electrolytes including sodium hexafluorophosphate, ethylene carbonate, diethyl carbonate, dimethyl carbonate, ethyl methyl carbonate, tetrahydrofuran, Ca(BF₄)₂NaPF₆, or combinations thereof.

In embodiments, the battery of the present disclosure exhibits a battery cycle life of at least about 5 cycles with 100% capacity retention, such as at least about 5 cycles, at least about 10 cycles, at least about 20 cycles, at least about 30 cycles, at least about 50 cycles, at least about 100 cycles, at least about 150 cycles, at least about 200 cycles, at least about 250 cycles, at least about 300 cycles, at least about 350 cycles, at least about 400 cycles, at least about 450 cycles, at least about 500 cycles, and so forth, or any value contained within a range formed by any two of the preceding values. In embodiments, the battery of the present disclosure exhibits a battery cycle life of at least about 500 cycles with at least about 75% capacity retention. In embodiments, the battery of the present disclosure exhibits a battery cycle life of at least about 1000 cycles with at least about 75% capacity retention, such as at least about 75%, at least about 80%, at least about 90%, about 100%, or any value contained within a range formed by any two of the preceding values.

Any method of assembling and operating the battery of the present disclosure may be employed.

The embodiments disclosed herein may be combined in any manner to form new embodiments.

### EXAMPLES

The following examples were carried out according to embodiments of the present disclosure.

### Example 1—Isolation of Xylem

The following materials and equipment were obtained:
Fresh plant stem or branch
Scalpel or razor blade
Forceps
Microscope (optional, for verification)
Vibratome
Petri dishes or containers
Sterile working conditions

Plant Selection: A healthy and fresh plant stem or branch was chosen for the isolation of xylem tissue.

Dissecting the Stem: Using a scalpel or razor blade, a longitudinal incision was performed on the stem, starting by cutting away the outer bark (phloem) until reaching the center (xylem), exposing the xylem.

Xylem Extraction: Using a Vibratome or alternative instrument suitable for the task, the isolated xylem was sliced into desired thickness and dimension. Generally, dimensions of about 50 to 60 μm are contemplated, though larger or smaller dimensions may be appropriate for differently sized batteries. The isolated tissue was verified as xylem by examination under a microscope for characteristics of xylem vessel elements and tracheids. The isolated xylem tissue was placed in a sterile contained and stored in a freezer until use.

### Example 2—Xylem Coating Method

The following materials and equipment were obtained:
Polyvinylidene fluoride (PVDF) powder or solution
Ethylene Carbonate (EC) and Propylene Carbonate (PC)
N-methyl-2-pyrrolidone (NMP) or other suitable solvent
Mixing equipment (e.g., magnetic stirrer)
Coating equipment (e.g., spin coater, doctor blade, or slot-die coater)
Substrate (xylem) to be coated
Vacuum oven or suitable drying equipment
Appropriate Personal Protective Equipment (PPE)

Preparation of PVDF solution: PVDF solution was prepared by dissolving the PVDF in a suitable solvent to prepare a 10-20% (w/v) solution of PVDF. Specifically, 10-20 g of PVDF was dissolved in 100 mL of a 1:1 mixture of EC:PC. The mixture was stirred until the PVDF was completely dissolved. Heating, for example at a temperature of about 50° C. to about 100° C. when using PVDF, and extended stirring until completely dissolved may be employed as needed.

Preparation of EC:PC solution: The EC:PC solution was prepared by combining the desired ratio of EC and PC. The solution was stirred until the binder fully dissolved. The PVDF solution and the EC:PC solution were combined in a 1:1 molar ratio. The solutions were mixed thoroughly to yield a homogeneous solution.

The xylem substrate was cleaned with isopropyl alcohol to ensure good adhesion of the PVDF. The mixed polymer and binder solution was applied to the xylem substrate using the chosen coating method. For example, spin coating may be used as the coating method. In a non-limiting example, a spin speed of about 1000 rpm to about 4000 rpm and a spin time of a few seconds up to several minutes were used for PVDF. The coating thickness may be adjusted as needed by one skilled in the art, such as by adjusting the solution viscosity, coating speed, and other variables. It is contemplated that a PVDF solution concentration of about 5% to about 20% w/v may be utilized in the present method. Other concentrations may be utilized for other coating materials.

The coated xylem was dried in a vacuum oven at 60° C. for 48 hours. Other optional processing steps, including annealing, may be performed on the coated xylem after drying.

### Example 3—Coated Xylem Characterization

The following materials and equipment were obtained:
Impedance Spectrometer and Potentiostat: High-quality impedance spectrometer capable of generating AC signals across a range of frequencies and measuring the corresponding responses. If not integrated into the impedance spectrometer, a potentiostat may be required for controlling the potential or current during the measurement.
Electrochemical Cell: Cell components, including a Swagelok cell or other suitable cell compartment, sample holder, stainless steel electrodes on either end, or other inert working electrode and counter electrode.
Computer and Software: A computer for instrument control and data analysis that has a specialized software for EIS measurement and analysis.
Electrodes: Inert electrodes made of materials such as stainless steel, platinum, or gold that do not interact with the electrolyte.
Electrolyte: The electrolyte sample of interest, here 0.25M calcium triflate and 1M calcium chloride, prepared according to the specifications of the experiment.
Cables and Connectors: High-quality cables and connectors to ensure proper electrical connections between the components.
Faraday Cage (recommended): To protect the setup from external electromagnetic interference and ensure accurate data measurements.

The coated xylem of the present disclosure was characterized by electrochemical impedance spectroscopy (EIS) using the following procedure.

### Sample Preparation:

The electrolyte samples of 1M calcium chloride and 0.25M calcium triflate were prepared. The coated xylem was inserted into a Swagelok cell and soaked with the electrolyte (about 60 μL), after visually ensuring that the electrolyte was homogeneous and free of any contaminants. The coated xylem soaked with the electrolyte was placed between two electrodes, in this case stainless steel rods were chosen (other electrodes may also be utilized).

### Electrochemical Cell Setup:

The Swagelok electrochemical cell was assembled with the prepared electrolyte sample and stainless steel electrodes, one used as working electrode and the other as counter and reference electrode. Working, reference, and counter electrodes with known properties were used. Common electrode materials include stainless steel, platinum, gold, or other inert conductive materials. After each measurement, the cell compartment and electrodes were cleaned appropriately for the next measurement.

### Instrument Connection:

The electrochemical cell was connected to the impedance spectrometer, ensuring proper wiring of connections to measure the impedance accurately.

### Electrochemical Impedance Spectroscopy Setup:

The parameters for the EIS measurement were set on the impedance spectrometer, including the frequency range, amplitude, and the like. These parameters are not particularly limited and may be selected by one of ordinary skill in the art. The frequency ranges for the calcium triflate and calcium chloride ionic conductivity measurements were from 0 Hz to 10 mHz.

### Initialization and Stabilization:

The system was allowed to equilibrate and stabilize for approximately 2 minutes or less before initiating the EIS measurement. Equilibration and stabilization helps in obtaining reliable and reproducible results, without wishing to be bound by theory.

### EIS Measurement:

The EIS measurement was initiated by applying a small-amplitude AC voltage signal across the electrodes. Here, a 10 mV rms AC voltage was applied in each step. The response of the system as a function of frequency was recorded. The impedance data was represented as impedance vs. frequency plots, also known as Nyquist plots and Bode plots.

### Data Analysis:

The obtained impedance data was analyzed to extract information about the ionic conductivity of the electrolyte by looking at the high-frequency response of the system. The data was fitted to appropriate equivalent circuit models that represent the electrical behavior of the system.

### Interpretation:

The relevant parameters such as bulk resistance, charge transfer resistance, and Warburg impedance were extracted to interpret the ionic conductivity of the electrolyte. The resulting EIS data for the coated xylem of the present disclosure in calcium chloride and calcium triflate are shown in FIGS. 7A and 7B.

### Example 4—Battery Assembly

The following materials and equipment were obtained:
Anode (calcium metal)
Cathode (calcium intercalated bilayer graphene, CaV₂O₅, CaTiS₂, CaC₆)
Coated xylem structure
Separator
Electrolyte solution (0.1M Ca(BF₄)₂-0.9M (NaPF₆) EC/DEC/DMC/EMC (7:1:6:6, v/v))
Coin cell components (coin cell case, sealing ring, and cap)
Coin cell crimper
Glovebox
Vacuum pump and vacuum gauge
Heat sealer (if needed)
Safety equipment, including gloves and lab coat

Preparation: The glove box was purged with inert gas to create an oxygen-free environment.

Anode and Cathode Loading: The anode material was placed on the anode side of the separator, and a small amount of electrolyte solution (about 60 μL) was applied to the anode to ensure the anode was evenly wetted. The cathode material was placed on the cathode side of the separator and the electrolyte was similarly applied to the cathode.

Coin cell assembly: The coated xylem structure and separator were placed, with the anode and cathode, into the bottom of the coin cell case. The separator was adjusted to the coin cell dimensions and excess material was trimmed away. Additional electrolyte solution was added to ensure proper wetting of the components.

Sealing and crimping: The sealing ring was placed onto the separator inside the coin cell case, with the cap aligned over the sealing ring. A heat sealer may be used to seal the coin cell tightly. The assembled coin cell was inserted into the coin cell crimper and crimped to ensure a tight seal.

Testing: The coin cell battery was testing with initial characterization methods including voltage and capacity checks.

The coin cell may be removed from the glove box according to standard glove box procedures.

Other battery assembly methods may include the use of pouch cells. Pouch cells have a flexible, flat pouch-like structure. Electrode materials, coated xylem structure, separator, and electrolyte are stacked and sealed within the pouch. The sealing method uses heat sealing or ultrasonic welding of the pouch. Pouch cells are then vacuum sealed to remove air and ensure better electrolyte soaking.

Further battery assembly methods include the use of cylindrical cells. The assembly method includes wound or stacked electrode materials, the coated xylem structure, and a separator, tacking the components within a cylindrical metal casing, and then sealing it airtight with a cap.

Further battery assembly methods may include the use of prismatic cells. Prismatic cells are typically rectangular and have a stacking design similar to pouch cells and are sealed within a rigid prismatic container.

This disclosure is not limited to the particular systems, devices and methods described, as these may vary. The terminology used in the description is for the purpose of describing the particular versions or embodiments only and is not intended to limit the scope.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 compounds refers to groups having 1, 2, or 3 compounds. Similarly, a group having 1-5 compounds refers to groups having 1, 2, 3, 4, or 5 compounds, and so forth.

Various of the above-disclosed and other features and functions, or alternatives thereof, may be combined into many other different systems or applications. Various presently unforeseen or unanticipated alternatives, modifications, variations, or improvements therein may be subsequently made by those skilled in the art, each of which is also intended to be encompassed by the disclosed embodiments.

What is claimed is:

1. A battery, comprising:
an anode comprising an alkali metal, an alkaline earth metal, or a combination thereof;
a cathode comprising a carbon allotrope;
a porous separator comprising xylem coated with a coating material; and
an electrolyte.

2. The battery of claim 1, wherein the anode comprises lithium, calcium, potassium, sodium, beryllium, magnesium, zinc, aluminum, or combinations thereof.

3. The battery of claim 1, wherein the cathode comprises a carbon allotrope intercalated with CaV₂O₅, CaTiS₂, CaC₆, or combinations thereof.

4. The battery of claim 1, wherein the carbon allotrope comprises graphite, graphene, or a combination thereof.

5. The battery of claim 1, wherein the xylem is obtained from a plant of the Crassula, Cycas, Takhtajania, Tasmannia, Drimys, Pseudowintera, Zygogynum, or Tetracentron genera.

6. The battery of claim 1, wherein the xylem is obtained from Crassula ovata, Crassula alata, Crassula capitella, Crassula lactea, Crassula nealeana, Crassula perforata, Cycas revoluta, Cycas tropophylla, Cycas circinalis, Cycas media, Cycas orixensis, Cycas platyphylla, Cycas pectinate, Tetracentron sinense, Drimys andina, Drimys angustifolia, Drimys brasiliensis, Drimys confertifolia, Drimys granadensis, Drimys roraimensis, Drimys winteri, or combinations thereof.

7. The battery of claim 1, wherein the xylem is secondary xylem.

8. The battery of claim 1, wherein the coating material comprises polyvinylidene fluoride, polytetrafluoroethylene, polyvinyl chloride, polystyrene, polypropylene, polyethylene, polycarbonate, polyethylene oxide, polymethyl methacrylate, polyacrylonitrile, tetrahydrofuran, ethylene carbonate, propylene carbonate, or combinations thereof.

9. The battery of claim 1, wherein the xylem is further coated with carbon nanotubes.

10. The battery of claim 1, wherein electrolyte comprises calcium tetrafluoroborate, sodium hexafluorophosphate, ethylene carbonate, diethyl carbonate, dimethyl carbonate, ethyl methyl carbonate, tetrahydrofuran, or combinations thereof.

11. A method of preparing coated xylem, comprising:
applying a coating solution comprising a coating material to xylem using a coating method to form coated xylem, and
drying the coated xylem.

12. The method of claim 11, further comprising isolating the xylem from Crassula ovata, Crassula alata, Crassula capitella, Crassula lactea, Crassula nealeana, Crassula perforata, Cycas revoluta, Cycas tropophylla, Cycas circinalis, Cycas media, Cycas orixensis, Cycas platyphylla, Cycas pectinate, Tetracentron sinense, Drimys andina, Drimys angustifolia, Drimys brasiliensis, Drimys confertifolia, Drimys granadensis, Drimys roraimensis, Drimys winteri, or combinations thereof.

13. The method of claim 11, further comprising preparing the coating solution, wherein preparing the coating solution comprises dissolving the coating material in a solvent comprising N-methyl-2-pyrrolidone, dichloromethane, dimethyl carbonate, ethyl methyl carbonate, or combinations thereof.

14. The method of claim 11, wherein the coating material comprises polyvinylidene fluoride, polytetrafluoroethylene, polyvinyl chloride, polystyrene, polypropylene, polyethylene, polycarbonate, polyethylene oxide, polymethyl methacrylate, polyacrylonitrile, tetrahydrofuran, or combinations thereof.

15. The method of claim 11, wherein the coating material comprises a binder comprising ethylene carbonate, propylene carbonate, or a combination thereof.

16. The method of claim 11, wherein the coating method comprises spin coating, doctor blading, slot-die coating, dip coating, bar coating, or combinations thereof.

17. The method of claim 11, further comprising applying carbon nanotubes to the xylem.

18. The method of claim 11, wherein drying the coated xylem comprises vacuum drying at a temperature of about 25° C. to about 75° C.

19. The method of claim 11, further comprising annealing the coated xylem.

20. The method of claim 11, further comprising densifying the xylem.

21. A composition, comprising:
xylem isolated from a plant of the Crassula, Cycas, Takhtajania, Tasmannia, Drimys, Pseudowintera, Zygogynum, or Tetracentron genera coated with a coating material.

22. The composition of claim 21, wherein the coating material comprises polyvinylidene fluoride, polytetrafluoroethylene, polyvinyl chloride, polystyrene, polypropylene, polyethylene, polycarbonate, polyethylene oxide, polymethyl methacrylate, polyacrylonitrile, tetrahydrofuran, or combinations thereof.

23. The composition of claim 21, wherein the coating material comprises a binder comprising ethylene carbonate, propylene carbonate, or a combination thereof.

24. The composition of claim 21, wherein the xylem is further coated with carbon nanotubes.

25. The composition of claim 21, wherein the xylem is secondary xylem.

26. The composition of claim 21, wherein the plant is Crassula ovata, Crassula alata, Crassula capitella, Crassula lactea, Crassula nealeana, Crassula perforata, Cycas revoluta, Cycas tropophylla, Cycas circinalis, Cycas media, Cycas orixensis, Cycas platyphylla, Cycas pectinate, Tetracentron sinense, Drimys andina, Drimys angustifolia, Drimys brasiliensis, Drimys confertifolia, Drimys granadensis, Drimys roraimensis, Drimys winteri, or combinations thereof.
